(19) United States
(12) Patent Application Publication
(10) Pub. No.: US 2005/0240946 A1
(43) Pub. Date: Oct. 27, 2005

(54) Device for handling at least one optical disc, and method for this purpose

(75) Inventors: Michael Van Der Aa, Eindhoven (NL); Gerard Nijsse, Eindhoven (NL); Gerardus Jansen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., BRIARCLIFF MANOR (NL)

(21) Appl. No.: 10/520,203

(22) PCT Filed: Jun. 24, 2003
(86) PCT No.: PCT/IB03/02650

§ 371 Date: Jan. 4, 2005

(30) Foreign Application Priority Data
Jul. 8, 2002 (EP) 02077729.8

(51) Int. Cl. G11B 17/04

(52) U.S. Cl. 720/620

(57) ABSTRACT

A device for handling at least one optical disc which comprises two main surfaces and a circumferential edge (12) interconnecting the main surfaces. The device is provided at least with a loading mechanism (30), which loading mechanism is provided with means (31, 32; 33, 34; 36, 37). Said means can be fastened during operation against at least two positions on the circumferential edge of the optical disc that can be positioned in the loading mechanism, which positions are at a distance from one another.

The invention relates to a device for handling at least one optical disc which comprises two main surfaces and a circumferential edge interconnecting said main surfaces, which device is provided at least with a loading mechanism.

The invention further relates to a method of handling at least one optical disc which comprises two main surfaces and a circumferential edge interconnecting said main surfaces, whereby the optical disc is inserted into a device comprising a loading mechanism.

Such a device for and method of handling an optical disc are known from US patent U.S. Pat. No. 4,802,155. The known device is provided with a loading mechanism into which an optical disc is loaded. The optical disc has two main surfaces and a circumferential edge interconnecting the main surfaces. The loading mechanism is provided with a clamping means by which the optical disc is gripped at its main surfaces. The clamping means brings the optical disc into the loading mechanism and from there displaces it into a handling device, in which a reading or writing device is situated.

The known device has the disadvantage that surface area should be available on the main surfaces of the optical disc where the clamping means can apply itself to the main surfaces of the optical disc. This surface area should preferably be located outside an area of the main surface where data can be written or read, so as to prevent damage to the data registered on the main surface.

The invention has for its object to provide a device with which an optical disc can be displaced by the loading mechanism, while the surface area to be contacted by the loading mechanism on the main surfaces is a minimum.

This object is achieved in the device according to the invention in that the loading mechanism is provided with means which can be fastened during operation against at least two positions on the circumferential edge of the optical disc to be positioned in the loading mechanism, which positions are located at a distance from one another.

An advantage of fastening on the circumferential edge of the optical disc is that the main surfaces of the optical disc are not or substantially not touched by the means of the loading mechanism. As a result, substantially the entire surface area of the main surface of the substrate layer can serve as a data layer. In addition, the comparatively long circumferential edge of an optical disc of comparatively small diameter is highly suitable for gripping of the disc in a stable manner without the disc pivoting or the like.

An embodiment of the device according to the invention is characterized in that the optical disc is provided with a substrate layer and a protective plate which each comprise two main surfaces and a circumferential edge interconnecting the main surfaces, while the loading mechanism is provided with at least one U-shaped holder, which U-shaped holder comprises two legs and a bridge interconnecting the legs, such that the legs of the holder during operation can be fastened against at least two positions, situated at a distance from one another, of the circumferential edge of the substrate layer that can be positioned in the loading mechanism or of the protective plate.

Such a U-shaped holder is of a comparatively simple construction, while the protective plate and the substrate layer can be separated from one another comparatively quickly by means of the U-shaped holder, such that the main surface of the substrate layer screened off by the protective plate becomes accessible to a processing device such as a reading or writing device.

A further embodiment of the device according to the invention is characterized in that the loading mechanism is provided with two U-shaped holders, such that during operation the legs of a first U-shaped holder can be fastened against the circumferential edge of the protective plate and the legs of a second U-shaped holder can be fastened against the circumferential edge of the substrate layer during operation, while the bridges of the two U-shaped holders are connected to one another with hinging possibility about a pivot axis extending parallel to the bridges.

It is an advantage of such an embodiment that the protective plate and the substrate layer can both be securely gripped by the respective U-shaped holders and can be separated from one another in a fast, comparatively simple manner, whereby the contact between the protective plate and the substrate layer is broken comparatively quickly.

A yet further embodiment of the device according to the invention is characterized in that the loading mechanism is provided with two U-shaped holders, such that during operation the legs of a first U-shaped holder can be fastened against the circumferential edge of the protective plate and the legs of a second U-shaped holder can be fastened against the circumferential edge of the substrate layer during operation, while the bridges of the two U-shaped holders are pivotable about a pivot axis extending transversely to the bridges.

An advantage of such an embodiment is that the substrate layer and the protective plate can be separated from one another in a comparatively simple manner. Since the substrate layer and/or the protective plate are/is displaced in a plane parallel to the main surfaces, the device can be of a comparatively compact construction. In addition, an initial slight pivoting movement, which breaks the contact between the substrate layer and the protective plate, followed by a swiveling movement renders it possible to remove the protective plate from the main surface of the substrate layer without friction between the protective plate and the substrate layer.

Another embodiment of the device according to the invention is characterized in that the optical disc is provided with a substrate layer and a protective layer, which substrate layer comprises two main surfaces and a circumferential edge interconnecting the main surfaces, while the loading mechanism is provided with at least two pulleys, an endless belt arranged around the pulleys, and a guide element, such that during operation the circumferential edge of the substrate layer that can be positioned in the loading mechanism can be positioned between the guide element and the endless belt.

An advantage of such an embodiment is that the substrate layer is separated from the protective plate in a simple and compact manner by means of a translatory displacement.

The invention also has for its object to provide a method by which the disadvantages of the known method are avoided.

This object is achieved in the method according to the invention in that means located in the loading mechanism are fastened against at least two positions oil the circumferential edge of the optical disc, said positions being located at a distance from one another, by which means the optical disc is displaced into and from the loading mechanism.

It is an advantage of such a method that the main surfaces of the optical disc substantially need not be touched during gripping of the optical disc.

A further method according to the invention is characterized in that the optical disc is provided with a substrate layer and a protective plate which each comprise two main surfaces and a circumferential edge interconnecting the main surfaces, while the loading mechanism is provided with means which are fastened against two positions of the circumferential edge of the substrate layer or of the protective plate which are situated at a distance from one another, whereupon the protective plate and the substrate layer are separated from one another by said means.

An advantage of such a method is that the optical disc is positioned in the loading mechanism in a comparatively simple manner. In addition, the protective plate is separated from the substrate layer by said means, whereby the main surface of the substrate layer initially screened off by the protective plate becomes accessible to a processing device.

A yet further method according to the invention is characterized in that the protective plate is pivoted with respect to the substrate layer about a pivot axis extending parallel to the main surfaces by said means.

An advantage of such an embodiment is that the protective plate and the substrate layer can be separated in an efficient, fast, and comparatively simple manner, whereby the contact between the protective plate and the substrate layer is broken comparatively quickly.

A further method according to the invention is characterized in that said means swivel the protective plate with respect to the substrate layer about a swivel axis extending transversely to the main surfaces.

It is an advantage of such a method that the separation of the protective plate from the substrate layer by means of a rotary movement about a swivel axis is comparatively simple.

A yet further method according to the invention is characterized in that said means displace the substrate layer with respect to the protective plate in a direction extending parallel to the main surfaces.

An advantage of such a method is that the substrate layer can be separated from the protective plate in a compact manner.

The invention will now be explained in more detail, by way of example, with reference to the accompanying drawings, in which:

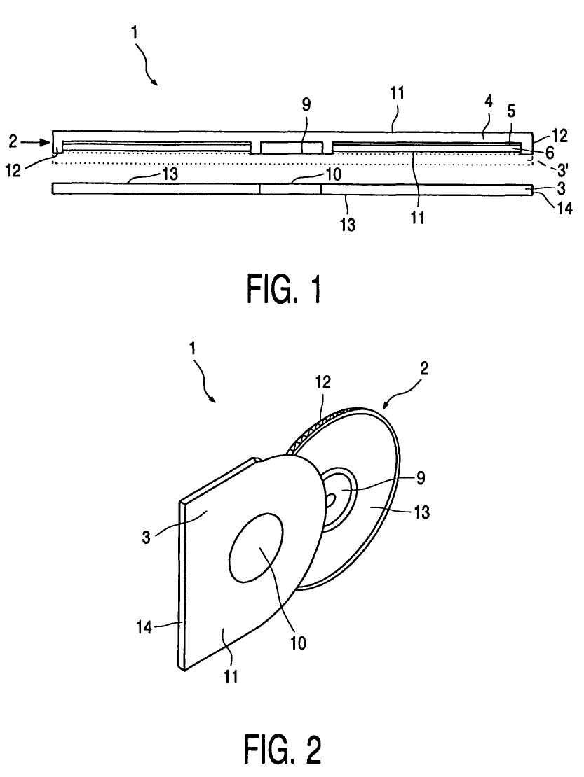

FIG. 1 is a diagrammatic cross-sectional view of a first embodiment of an optical disc,

FIG. 2 is a perspective lateral view of a second embodiment of an optical disc,

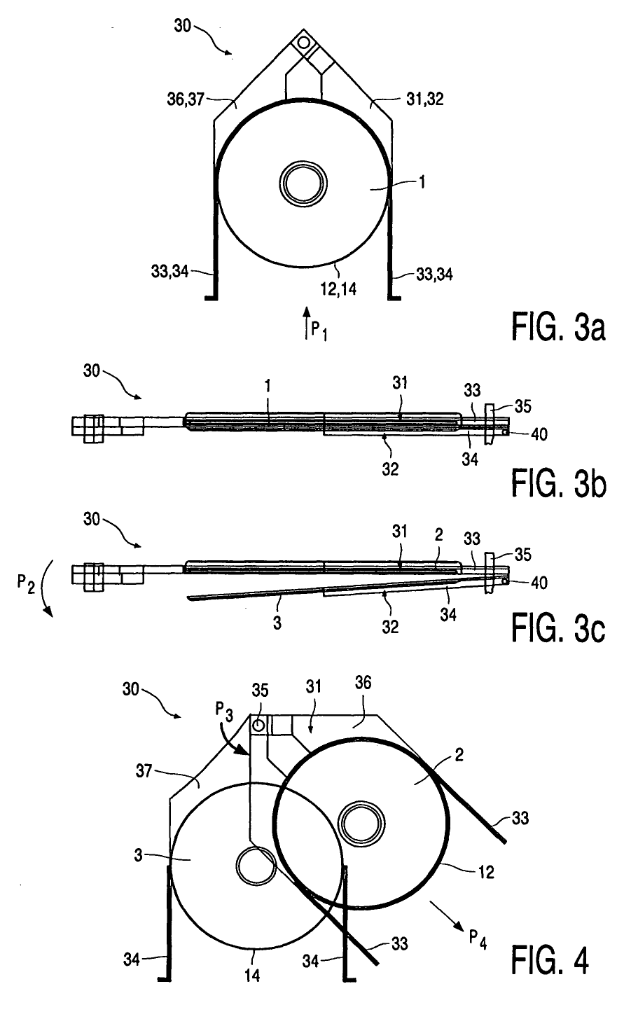

FIG. 3a is a diagrammatic plan view, and FIGS. 3b and 3c are cross-sectional views of a first embodiment of a loading mechanism according to the invention located in a device,

FIG. 4 is a diagrammatic plan view of the embodiment shown in FIGS. 3a to 3c of a loading mechanism according to the invention located in a device in a different position, and

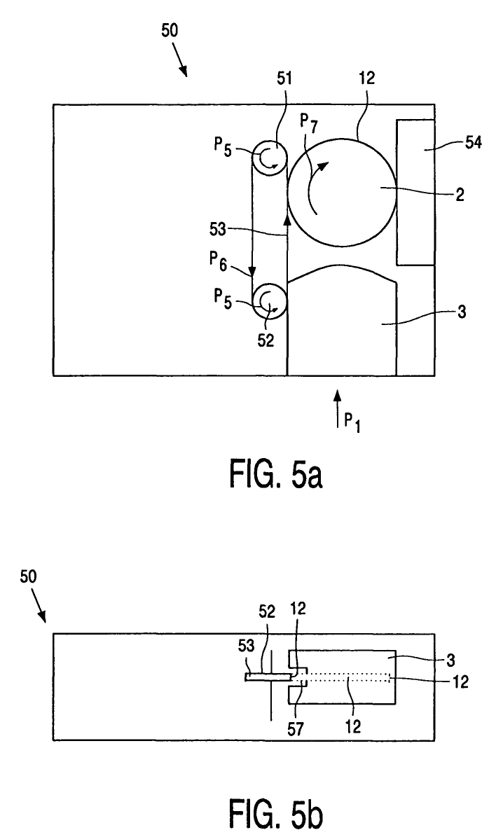

FIGS. 5a and 5b are a diagrammatic plan view and side elevation of a second embodiment of a loading mechanism according to the invention located in a device.

Corresponding components have been given the same reference numerals in the Figures.

FIG. 1 is a diagrammatic cross-sectional view of a first embodiment of an optical disc 1. The optical disc 1 comprises a substrate layer 2 and a detachable protective plate 3 that can be coupled to said disc. The circular substrate layer 2 comprises a support plate 4, a registration layer 5 connected thereto, and a covering layer 6 connected to the registration layer 5 at a side of the registration layer 5 facing away from the support plate 4. The covering layer 6, which is thin compared with the support plate 4, is manufactured from a material transparent to a reading or writing medium. The support plate 4 is manufactured from a hard material, for example metal or synthetic resin. A magnet 9 is located in the center of the support plate 4.

A protective plate 3, which can be detachably fastened to the substrate layer 2, is situated opposite the substrate layer at the side facing away from the support plate 4. A magnet 10 is located in the central portion of the protective plate 3.

The function of the protective plate 3 will now be briefly explained. To protect the registration layer 5, the protective plate 3 is moved from the side of the covering layer 6 from its position indicated with continuous lines into the position indicated with dotted lines representing the protective plate 3′, where the protective plate 3′ is detachably fastened to the support plate 4 by means of the magnets 9, 10. The protective plate 3 is positioned as well as retained on the substrate layer 2 by the magnets 9, 10.

The substrate layer 2 is provided with two main surfaces 11 formed by the support plate 4 and the covering layer 6, and with a circumferential edge 12 interconnecting the main surfaces 11. The protective plate 3 is provided with two main surfaces 13 and a circumferential edge 14 interconnecting the main surfaces 13.

FIG. 2 is a perspective lateral view of a second embodiment of an optical disc 1. In this embodiment, the optical disc I comprises a sleeve-type protective plate 3 and a substrate layer 2. The substrate layer 2 has the same constriction as in FIG. 1. The sleeve-type protective plate 3 comprises a magnet 10. The substrate layer 2 is slid into the sleeve-type protective plate 3 for protection purposes. The substrate layer 2 is substantially entirely enclosed and protected by the sleeve-type protective plate 3.

FIGS. 3a to 3c and FIG. 4 are elevations of an embodiment of a loading mechanism 30 according to the invention located in a device in which an optical disc 1 is positioned. The loading mechanism 30 comprises two U-shaped holders 31, 32, each having two legs 33, 34 and a bridge 36, 37 connecting said legs 33, 34.

The U-shaped holder 31 can swivel about a swivel axis 35 that extends transversely to the bridge 36, and the U-shaped holder 32 is pivotable about a pivot axis 40 that extends parallel to the bridge 37.

The operation of the loading mechanism 30 will now be briefly explained. An optical disc 1 is manually inserted between the legs 33, 34 of the U-shaped holder 31, 32 in the direction indicated by arrow P1, such that the circumferential edge 12 of the substrate layer 2 is clamped between the legs 33 of the U-shaped holder 31, while at the same time the circumferential edge 14 of the protective plate 3 is gripped by the legs 34 of the U-shaped holder 32. Starting from the position shown in FIG. 3a, the U-shaped holder 32 is pivoted about the pivot axis 40 in the direction indicated by arrow P2 (FIG. 3c), whereupon the U-shaped holder 31 with the substrate layer 2 situated therein is swiveled about the swivel axis 35 in the direction indicated by arrow P3 into the position shown in FIG. 4. In this position, the substrate layer may be directly written or read by writing and/or reading means, or it may be moved in the direction indicated by arrow P4 from the U-shaped holder 31 by means (not shown) for further processing.

FIGS. 5a and 5b are a plan view and a side elevation of a second embodiment of a loading mechanism 50 located in a device. The loading mechanism 50 is provided with two pulleys 51, 52, and an endless belt 53 arranged around the pulleys 51, 52. The loading mechanism 50 is further provided with a guide element 54 extending parallel to the endless belt 53 at a distance therefrom. The optical disc 1 shown in FIG. 2 is placed in the loading mechanism 50, said optical disc 1 comprising a substrate layer 2 and a sleeve-type protective plate 3.

The sleeve-type protective plate 3 comprises a slotted recess 57 in its circumferential edge 14, through which the substrate layer 2 partly extends.

The operation of the loading mechanism 50 will now be briefly explained. The optical disc 1 is inserted into the loading mechanism 50 in the direction indicated by arrow P1 until the sleeve-type protective plate 3 hits against an abutment (not shown). The recess 57 is now located opposite the pulley 52, such that the belt 53 provided around the pulleys 51, 52 bears on the circumferential edge 12 of the substrate layer 2 situated in the protective plate 3. The substrate layer 2 furthermore bears on a wall of the sleeve-type protective plate 3 remote from the recess 57. The pulleys 51, 52 are subsequently driven in the direction indicated by arrow P5, so that the belt 53 is displaced in the direction indicated by arrow P6. As a result, the substrate layer 2 will start rotating in the direction indicated by arrow P7 and be rolled from the sleeve-type protective plate 3. After the substrate layer 2 has moved partly from the protective plate 3, the circumferential edge 12 of the substrate layer 2 will come into contact with the guide element 54 and be rolled away along the latter.

It will be apparent both in the loading mechanism 30 and the loading mechanism 50 that a renewal of the contact between the substrate layer 2 and the protective plate 3 can also be achieved by the loading mechanism.

The loading mechanism 30, 50 is situated in a device which may be provided, for example, with a writing and/or reading unit.

It is alternatively possible to provide the loading mechanism 30 with a swivel axis 35 only or with a pivot axis 40 only.

It is also possible to provide the loading mechanism 50 with endless belts around pulleys on either side of the substrate layer 2, in which case the substrate layer 2 will be removed from the sleeve-type protective plate 3 in a translatory displacement.

It is furthermore possible to situate the legs 33 somewhat away from one another, such that the substrate layer 2 can be rotated between the legs 33 instead of being displaced in the direction indicated by arrow P4.

1. A device for handling at least one optical disc which comprises two main surfaces and a circumferential edge interconnecting said main surfaces, which device is provided at least with a loading mechanism, characterized in that the loading mechanism is provided with means which can be fastened during operation against at least two positions on the circumferential edge of the optical disc to be positioned in the loading mechanism, which positions are located at a distance from one another.

2. A device as claimed in claim 1, characterized in that the optical disc is provided with a substrate layer and a protective plate which each comprise two main surfaces and a circumferential edge interconnecting the main surfaces, while the loading mechanism is provided with at least one U-shaped holder, which U-shaped holder comprises two legs and a bridge interconnecting the legs, wherein during operation the legs of the holder can be fastened against at least two positions, situated at a distance from one another, of the circumferential edge of the substrate layer that can be positioned in the loading mechanism or of the protective plate.

3. A device as claimed in claim 2, characterized in that the loading mechanism is provided with two U-shaped holders, such that during operation the legs of a first U-shaped holder can be fastened against the circumferential edge of the protective plate and the legs of a second U-shaped holder can be fastened against the circumferential edge of the substrate layer during operation, while the bridges of the two U-shaped holders are connected to one another with hinging possibility about a pivot axis extending parallel to the bridges.

4. A device as claimed in claim 2, characterized in that the loading mechanism is provided with two U-shaped holders, such that during operation the legs of a first U-shaped holder can be fastened against the circumferential edge of the protective plate and the legs of a second U-shaped holder can be fastened against the circumferential edge of the substrate layer during operation, while the bridges of the two U-shaped holders are pivotable about a pivot axis extending transversely to the bridges.

5. A device as claimed in claim 1, characterized in that the optical disc is provided with a substrate layer and a protective layer, which substrate layer comprises two main surfaces and a circumferential edge interconnecting the main surfaces, while the loading mechanism is provided with at least two pulleys, an endless belt arranged around the pulleys, and a guide element, such that during operation the circumferential edge of the substrate layer that can be positioned in the loading mechanism can be positioned between the guide element and the endless belt.

6. A method of handling at least one optical disc which comprises two main surfaces and a circumferential edge interconnecting said main surfaces, whereby the optical disc is inserted into a device comprising a loading mechanism, characterized in that means located in the loading mechanism are fastened against at least two positions on the circumferential edge of the optical disc, said positions being located at a distance from one another, by which means the optical disc is displaced into and from the loading mechanism.

7. A method as claimed in claim 6, characterized in that the optical disc is provided with a substrate layer and a protective plate which each comprise two main surfaces and a circumferential edge interconnecting the main surfaces, while the loading mechanism is provided with means which are fastened against two positions of the circumferential edge of the substrate layer or of the protective plate, which positions are situated at a distance from one another, whereupon the protective plate and the substrate layer are separated from one another by said means.

8. A method as claimed in claim 7, characterized in that the protective plate is pivoted with respect to the substrate layer about a pivot axis that extends parallel to the main surfaces by said means.

9. A method as claimed in claim 7, characterized in that said means swivel the protective plate with respect to the substrate layer about a swivel axis that extends transversely to the main surfaces.

10. A method as claimed in claim 7, characterized in that said means displace the substrate layer with respect to the protective plate in a direction that extends parallel to the main surfaces.
